(19) United States
(12) Patent Application Publication
(10) Pub. No.: US 2026/0192816 A1
(43) Pub. Date: Jul. 9, 2026

(54) INFORMATION PROCESSING APPARATUS AND METHOD OF OPERATING INFORMATION PROCESSING APPARATUS

(71) Applicant: TOYOTA JIDOSHA KABUSHIKI KAISHA, Toyota-shi (JP)

(72) Inventors: Yu NAGATA, Chofu-shi (JP); Makoto MATSUSHITA, Ichinomiya-shi (JP); Kei KOSAKA, Meguro-ku (JP); Sho MINAGAWA, Nagoya-shi (JP); Haruka FUTATSUBASHI, Chiyoda-ku (JP); Ryota TATSUMI, Nagoya-shi (JP); Yo OKUMURA, Chofu-shi (JP); Toshifumi MICHIDA, Okazaki-shi (JP)

(73) Assignee: TOYOTA JIDOSHA KABUSHIKI KAISHA, Toyota-shi (JP)

(21) Appl. No.: 19/441,271

(22) Filed: Jan. 6, 2026

(30) Foreign Application Priority Data
Jan. 7, 2025 (JP) 2025-002539

(51) Int. Cl. B60W 50/14; B60L 58/13

(52) U.S. Cl. CPC B60W 50/14; B60L 58/13; B60L 2240/12; B60L 2240/642; B60L 2250/16; B60L 2260/54; B60W 2050/143; B60W 2050/146; B60W 2510/244; B60W 2520/10; B60W 2552/15; B60W 2552/30

(57) ABSTRACT

An information processing apparatus includes a memory that stores information on a travel route for a vehicle that travels using electric power, and information on a speed for each link when the vehicle travels multiple links included in the travel route, and a controller that outputs information on a total power consumption to be consumed by the vehicle to travel the travel route, based on a power consumption for each link according to a variation of the speed for each link.

### CROSS-REFERENCE TO RELATED APPLICATION

This application claims priority to Japanese Patent Application No. 2025-002539, filed on Jan. 7, 2025, the entire contents of which are incorporated herein by reference.

### TECHNICAL FIELD

The present disclosure relates to an information processing apparatus and a method of operating the information processing apparatus.

### BACKGROUND

Navigation apparatuses that calculate and present to a driver a route, travel time, and the like to a destination when a vehicle travels are known. The navigation apparatuses calculate the travel time based on conditions such as preference for ordinary roads or preference for expressways selected by the driver. As an example of the navigation apparatuses, Patent Literature (PTL) 1 discloses an apparatus that searches for a route for an electric vehicle and estimates power to be consumed in traveling the searched route, and presents the route and the power to a driver.

### CITATION LIST

### Patent Literature

PTL 1: JP 2014-066655 A

### SUMMARY

There is room for improvement in the estimation accuracy of power consumption in electric vehicles.

The following discloses an information processing apparatus and the like that enable improvement in the estimation accuracy of power consumption in electric vehicles.

An information processing apparatus according to the present disclosure includes:
a memory configured to store information on a travel route for a vehicle that travels using electric power, and information on a speed for each link when the vehicle travels multiple links included in the travel route; and
a controller configured to output information on a total power consumption to be consumed by the vehicle to travel the travel route, based on a power consumption for each link according to a variation of the speed for each link.

A method of operating an information processing apparatus according to the present disclosure includes:
acquiring information on a travel route for a vehicle that travels using electric power, and information on a speed for each link when the vehicle travels multiple links included in the travel route; and
outputting information on a total power consumption to be consumed by the vehicle to travel the travel route, based on a power consumption for each link according to a variation of the speed for each link.

According to the information processing apparatus and the like in the present disclosure, it is possible to improve the estimation accuracy of power consumption in electric vehicles.

### BRIEF DESCRIPTION OF THE DRAWINGS

In the accompanying drawings:

FIG. 1 is a diagram illustrating an example of a configuration of an information processing system;

FIG. 2 is a diagram explaining link attribute information;

FIG. 3 is a flowchart illustrating an example of operations of a server apparatus; and

FIG. 4 is a flowchart illustrating an example of operations of the server apparatus.

### DETAILED DESCRIPTION

An embodiment will be described below.

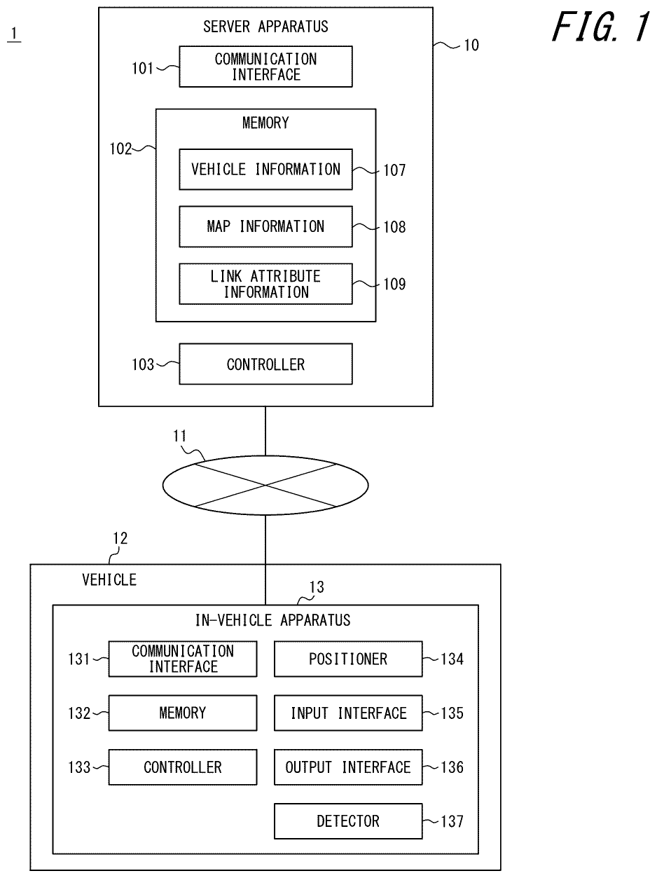

FIG. 1 is a diagram illustrating an example of a configuration of an information processing system according to the embodiment. An information processing system 1 includes at least one server apparatus 10 and at least one in-vehicle apparatus 13 that are communicably connected to each other via a network 11. The server apparatus 10 is, for example, a server computer that belongs to a cloud computing system or another computing system, and functions as a server that implements various functions. The in-vehicle apparatus 13 is, for example, a navigation system or the like that has a communication function and an information processing function, and is mounted on a vehicle 12. The vehicle 12 is a vehicle such as a passenger car or a commercial vehicle, and part or all of the driving is performed manually by a driver. The vehicle 12 is one that travels using electric power, such as a Battery Electric Vehicle (BEV) or a Fuel Cell Electric Vehicle (FCEV). The network 11 is the Internet, for example, but may also be an ad-hoc network, a LAN, a Metropolitan Area Network (MAN), other networks, or a combination of two or more thereof.

In the present embodiment, the information processing system 1 searches for a travel route for the vehicle 12, and derives a power consumption in the vehicle 12 when the vehicle 12 travels the travel route, and provides information on the travel route and the power consumption to the driver of the vehicle 12. In the present embodiment, the server apparatus 10 corresponds to “information processing apparatus,” and the server apparatus 10 has a memory 102 and a controller 103. The memory 102 stores information on the travel route for the vehicle 12 that travels using electric power, and information on a speed for each link when the vehicle 12 travels multiple links included in the travel route. The controller 103 outputs information on a total power consumption to be consumed by the vehicle 12 to travel the travel route, based on a power consumption for each link according to a variation of the speed for each link. The information on the total power consumption is transmitted to the in-vehicle apparatus 13 and presented to the driver by the in-vehicle apparatus 13. Here, the links are units in which the travel route is divided into approximately equal distances. Also, the speed for each link when the vehicle 12 travels the multiple links is an average speed obtained by dividing the distance of each link by travel time. When the vehicle 12 sequentially travels the multiple links, the speed for each link may increase or decrease, and there is a tendency for more power to be consumed at the timing when the speed increases or decreases from one link to the next link. In the present embodiment, the server apparatus 10 estimates the total power consumption to be consumed by the vehicle 12 to travel the travel route, based on the power consumption for each link according to the variation of the speed for each link, so it is possible to derive the total power consumption more accurately, compared to the case of deriving the total power consumption based solely on, for example, the length of the travel route or the travel speed of the vehicle 12 for each link included in the travel route. Therefore, it is possible to improve the estimation accuracy of power consumption in electric vehicles.

Next, an example of a configuration of the server apparatus 10 will be described.

The server apparatus 10 includes a communication interface 101, the memory 102, and the controller 103. The server apparatus 10 may be a single computer or may be two or more computers that are communicably connected to each other and operate in cooperation. When the server apparatus 10 is configured with two or more computers, the configuration illustrated in FIG. 1 is arranged as appropriate on the two or more computers.

The communication interface 101 includes one or more interfaces for communication. The interfaces for communication include, for example, a LAN interface. The communication interface 101 receives information to be used for operations of the controller 103, and transmits information obtained by operations of the controller 103. The server apparatus 10 is connected to the network 11 by the communication interface 101 and communicates information with the in-vehicle apparatus 13 via the network 11.

The memory 102 includes, for example, one or more semiconductor memories, one or more magnetic memories, one or more optical memories, or a combination of at least two of these types, to function as a main memory, an auxiliary memory, or a cache memory. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 102 stores information to be used for operations of the controller 103 and information obtained by operations of the controller 103.

The controller 103 includes one or more processors, one or more dedicated circuits, or a combination thereof. The processors are general purpose processors, such as central processing units (CPUs), or dedicated processors, such as graphics processing units (GPUs), dedicated to specific processing. The dedicated circuits are, for example, field-programmable gate arrays (FPGAs), application specific integrated circuits (ASICs), or the like. The controller 103 executes information processing related to the operations of the server apparatus 10 while controlling components of the server apparatus 10.

The functions of the server apparatus 10 are realized by execution of a control program by a processor included in the controller 103. The control program is a program for causing a computer to execute processing of steps included in the operations of the server apparatus 10, thereby enabling the computer to realize functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

The memory 102 stores, for example, map information 108, link attribute information 109, and vehicle information 107.

The map information 108 includes, for example, the positions of nodes of each road for dividing the travel route of the vehicle 12 into the links. The nodes are, for example, freely arranged at regular intervals of several tens to several hundreds of meters on a map in a plan view.

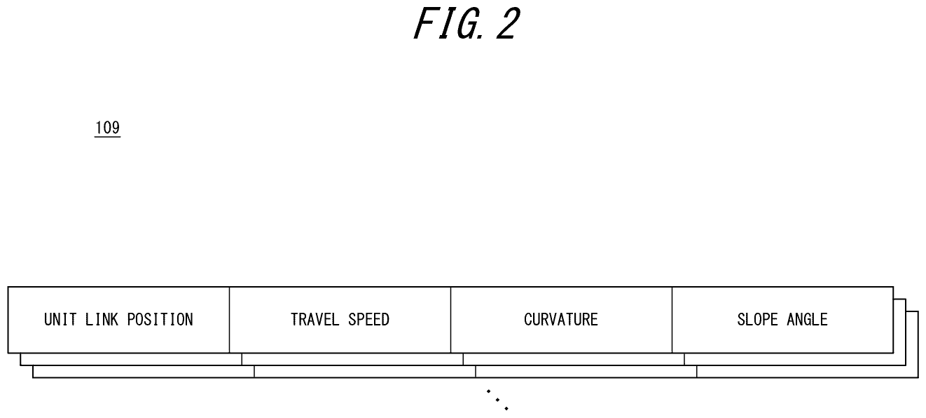

The link attribute information 109 is attribute information for each unit link with a pair of nodes at both ends, and includes, as illustrated in FIG. 2, the position of each unit link on the map, a travel speed required for the vehicle 12 to travel each unit link, information on the curvature of a curve included in each unit link, information on the slope angle of a road in each unit link, and the like. The travel speed of the vehicle 12 on each unit link is an average speed when one or more vehicles 12 travel each unit link, and such an average speed is determined from the distance of each unit link and time required for the vehicles 12 to travel each unit link. The required time for the vehicles 12 for each unit link is statistically pre-derived using various probe data collected by the server apparatus 10, for example. The probe data includes position information on the vehicles 12 collected from respective one or more in-vehicle apparatuses 13, or information indicating the passage of unspecified vehicles 12 collected from roadside devices or the like. The information on the curvature of the curve included in each unit link is pre-calculated from the map information 108. When a unit link includes multiple curves, the curvature of that unit link is, for example, the average of multiple curvatures. The information on the slope angle of the road for each unit link is calculated from the map information 108. The information on the slope angle includes the direction of a slope of the road. When a unit link includes multiple slopes, the slope angle of that unit link is, for example, the average of multiple slope angles.

The vehicle information 107 includes identification information on the vehicle 12 with which the server apparatus 10 communicates and performance information such as a power consumption rate depending on the vehicle type of the vehicle 12 pre-provided by a vehicle manufacturer or the like, in association with each other.

Next, an example of a configuration of the in-vehicle apparatus 13 will be described.

The in-vehicle apparatus 13 includes a communication interface 131, a memory 132, a controller 133, a positioner 134, an input interface 135, an output interface 136, and a detector 137. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 12, through an in-vehicle network compliant with a standard such as a controller area network (CAN).

The communication interface 131 includes a communication module compliant with a wired or wireless LAN standard, a module compliant with a mobile communication standard such as long term evolution (LTE), 4th generation (4G), or 5th generation (5G), or the like. The in-vehicle apparatus 13 connects to the network 11 via a nearby router apparatus or a mobile communication base station using the communication interface 131, and communicates information with other apparatuses over the network 11.

The memory 132 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 132 functions as, for example, a main memory, an auxiliary memory, or a cache memory. The memory 132 stores information to be used for operations of the controller 133 and information obtained by operations of the controller 133.

The controller 133 includes one or more processors, one or more dedicated circuits, or a combination thereof. The processors are general purpose processors such as CPUs, or dedicated processors such as GPUs that are specialized for specific processing. The dedicated circuits are, for example, FPGAs or ASICs. The controller 133 executes information processing related to operations of the in-vehicle apparatus 13 while controlling components of the in-vehicle apparatus 13.

The functions of the controller 133, such as navigation and multimedia reproduction, are realized by execution of a control/processing program by a processor included in the controller 133. The control/processing program is a program for causing a computer to execute processing of steps included in operations of the controller 133, thereby enabling the computer to realize the functions corresponding to the processing of the steps. That is, the control/processing program is a program for causing a computer to function as the controller 133. Some or all of the functions of the controller 133 may be realized by a dedicated circuit included in the controller 133.

The positioner 134 includes one or more global navigation satellite system (GNSS) receivers. The GNSS includes, for example, Global Positioning System (GPS), Quasi-Zenith Satellite System (QZSS), BeiDou, Global Navigation Satellite System (GLONASS), and/or Galileo. The positioner 134 transmits a positioning result to the controller 133, and the controller 133 calculates position information on the in-vehicle apparatus 13, that is, the vehicle 12.

The input interface 135 includes one or more interfaces for input. The interfaces for input include, for example, a microphone that accepts audio input, physical keys, capacitive keys, a pointing device, a touch screen integrally provided with a display, or the like. The interfaces for input include an interface with a camera that is provided in the vehicle 12 to capture images of the interior or exterior of the vehicle 12. The camera may be built into the in-vehicle apparatus 13 or may be separate. The input interface 135 accepts input operations of information to be used for operations of the controller 133 by a user such as a driver, voice, or captured images of the driver or the like by a camera, and transmits the accepted information to the controller 133.

The output interface 136 includes one or more interfaces for output. The interfaces for output include, for example, a speaker that outputs sound, a display that outputs images, and the like. The display is, for example, a liquid crystal display (LCD) or an organic electro-luminescent (EL) display. The output interface 136 outputs information to be obtained by operations of the controller 133.

The detector 137 has sensors that detect various events occurring in the vehicle 12, or interfaces with such sensors. The sensors include, for example, sensors that detect the speed, acceleration in a longitudinal direction, acceleration in a lateral direction, deceleration, accelerator operation amount, brake operation amount, steering angle, turn signal lighting time, fuel consumption per unit time, eco mode selection state, odometer value, safety equipment operation information, remaining amounts of engine oil and the like, degree of wear of brake pads, degree of battery degradation, and the like of the vehicle 12. The sensors include radar using millimeter waves, infrared rays, or the like that detects objects around the vehicle 12. The detector 137 transmits vehicle information indicating various states of the vehicle 12 detected by the sensors to the controller 133.

The controller 133 controls each of the communication interface 131, the memory 132, the positioner 134, the input interface 135, the output interface 136, and the detector 137 while exchanging various information with these components, and also controls operations of the vehicle 12. When the vehicle 12 travels, the controller 133 presents various information such as route information necessary for driving to the driver via the output interface 136 to provide a navigation function, and controls partial automated driving of the vehicle 12.

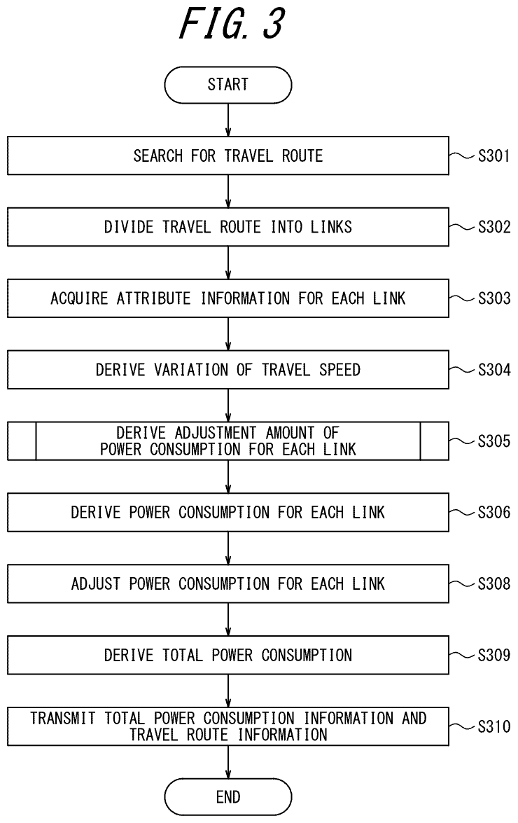

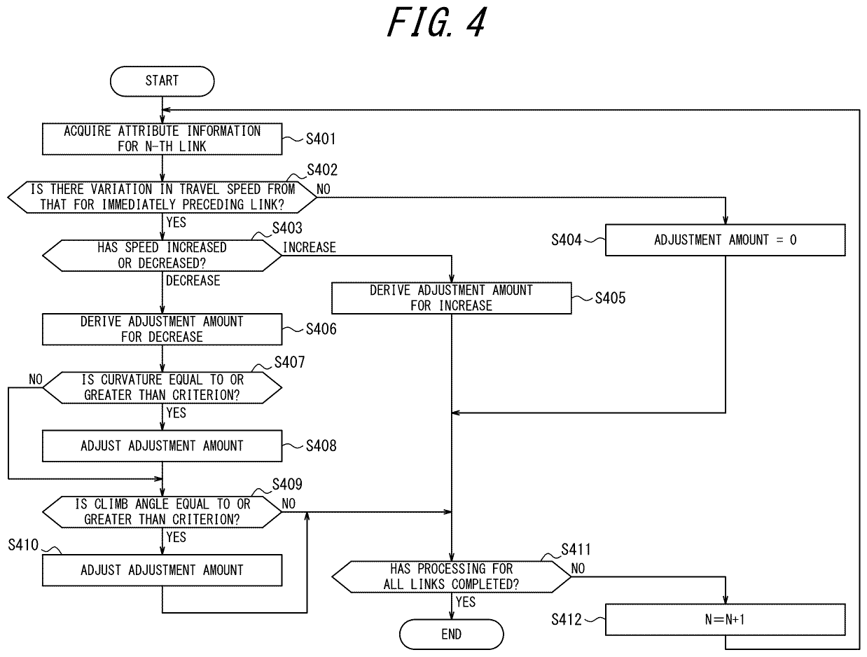

Next, operations of the server apparatus 10 will be described with reference to FIG. 3 and FIG. 4.

FIG. 3 is a flowchart illustrating an example of an operation procedure of the server apparatus 10. Each step in FIG. 3 is a step of information processing executed by the controller 103. The operation procedure in FIG. 3 is executed by the controller 103 in response to a request to search for a travel route for the vehicle 12 when the driver of the vehicle 12 operates the in-vehicle apparatus 13 to transmit the request to the server apparatus 10 and the controller 103 of the server apparatus 10 receives the request.

In S301, the controller 103 searches for a travel route. The controller 103 acquires information on the current position of the vehicle 12, a destination, a priority order for travel route selection, and the like from the in-vehicle apparatus 13. When the driver of the vehicle 12 inputs information on a destination, a priority order, and the like by operating the in-vehicle apparatus 13, the in-vehicle apparatus 13 transmits this information along with information on the current position of the vehicle 12 to the server apparatus 10. Based on the various information transmitted from the in-vehicle apparatus 13, the controller 103 searches for a travel route using the map information 108 and any algorithm. The controller 103 stores information on the searched travel route in the memory 102.

In S302, the controller 103 divides the travel route into links. The controller 103 divides the travel route into multiple equidistant links on a map in a plan view. The controller 103 divides the travel route into multiple links based on the positions of nodes associated with the map information 108. One link may be composed of a single unit link, or may be composed of multiple unit links.

In S303, the controller 103 acquires attribute information for each link. The controller 103 reads and acquires, from the link attribute information 109, attribute information for unit links corresponding to the travel route. When one link is composed of multiple unit links, the controller 103 may use the averages of travel speeds, curvatures, slope angles, and the like for the multiple unit links included in each link, as a travel speed, a curvature, a slope angle, and the like for that link. The controller 103 stores the attribute information including a travel speed for each link in the memory 102.

In S304, the controller 103 derives a variation of the travel speed. The controller 103 sequentially derives the difference between a travel speed for one link and a travel speed for the immediately preceding link along an expected travel direction of the vehicle 12 in the travel route. For example, a positive difference value is derived when the travel speed for the next link increases relative to that for a certain link, and a negative difference value is derived when the travel speed decreases.

In S305, the controller 103 derives an adjustment amount of the travel speed for each link. The adjustment amount of the travel speed here is a coefficient relative to the initial travel speed. A detailed procedure of step S305 is illustrated in FIG. 4.

As illustrated in FIG. 4, first in step S401, the controller 103 reads and acquires attribute information for an N-th link (N is a natural number, with an initial value of “1”) from the memory 102.

In S402, the controller 103 determines whether a travel speed for the N-th link has varied from that for the immediately preceding link. When the variation derived in step S304 is equal to or greater than any criterion, for example, an absolute value of 0.5 to 2.0 km/h, the controller 103 determines that there is a variation (“Yes” in S 402), and the process proceeds to step S403. When the variation is less than the criterion, the controller 103 determines that there is no variation (“No” in S402), and the process proceeds to step S404. Note that, in a first link, there is no preceding link, so it is determined that there is no variation.

In S403, the controller 103 determines whether the travel speed has increased or decreased from that for the preceding link. When the variation derived in step S304 is a positive value, the controller 103 determines that the travel speed has increased (“Increase” in S403), and the process proceeds to step S405. When the variation is a negative value, the controller 103 determines that the travel speed has decreased (“Decrease” in S403), and the process proceeds to step S406.

In S405, the controller 103 derives an adjustment amount for an increase in the travel speed. When the travel speed has increased from one link to the next link, for example, when the vehicle 12 has accelerated to merge onto a highway or when the vehicle 12 has accelerated after passing through a steady congestion or narrow road, the vehicle 12 is likely to have an increased power consumption due to acceleration, so a coefficient greater than 1 is derived as the adjustment amount. The adjustment amount for such an increase is derived so as to increase according to an increase amount in the travel speed. Information in which the adjustment amount is pre-associated with each increase range in the travel speed is stored in the memory 102, and the controller 103 may derive the adjustment amount using this information or may derive the adjustment amount using any formula.

On the other hand, in S406, the controller 103 derives an adjustment amount for a decrease in the travel speed. When the travel speed has decreased from one link to the next link, for example, when the vehicle 12 has decelerated to turn a curve or when the vehicle 12 has decelerated while climbing, the vehicle 12 is likely to have an increased power consumption due to re-acceleration after deceleration or due to increased output while climbing, so a coefficient greater than 1 is derived as the adjustment amount. The adjustment amount for such a decrease is derived so as to increase according to a decrease amount in the travel speed. Information in which the adjustment amount is pre-associated with each decrease range in the travel speed is stored in the memory 102, and the controller 103 may derive the adjustment amount using this information or may derive the adjustment amount using any formula. Note that, adjustment ranges for the adjustment amount for the increase in the variation and the adjustment amount for the decrease may be the same or different.

In S407, the controller 103 determines whether a curvature for the N-th link is equal to or greater than a certain criterion. The criterion is the curvature value of a relatively deep curve that causes the vehicle 12 to once decelerate in that link with a decreased travel speed and an increased power consumption for re-acceleration, and is set to any value such as 0.1(m⁻¹) corresponding to the curvature of a so-called hairpin curve. When the curvature is equal to or greater than the criterion (“Yes” in S407), the controller 103 proceeds to step S408. When the curvature is less than the criterion (“No” in S407), the controller 103 proceeds to step S409.

In S408, the controller 103 further adjusts the adjustment amount for the N-th link. The controller 103 increases the adjustment amount by adding any adjustment amount that increases according to the curvature to the adjustment amount for the decrease in the travel speed or by multiplying the adjustment amount for the decrease in the travel speed by a coefficient of 1 or more that increases according to the curvature. This allows for reflecting in the adjustment amount an increase in power consumption due to greater deceleration and re-acceleration when the vehicle 12 turns a deep curve such as a hairpin curve.

In S409, the controller 103 determines whether a climb angle for the N-th link is equal to or greater than a certain criterion. The criterion is the slope angle of a slope that causes the vehicle 12 to have a decreased travel speed and an increased power consumption for climbing, and is set to any value such as 7 to 10 degrees. Note that, the climb angle is determined based on an expected travel direction of the vehicle 12 and a slope angle included in the attribute information. When the climb angle is equal to or greater than the criterion (“Yes” in S409), the controller 103 proceeds to step S410. When the climb angle is less than the criterion (“No” in S409), the controller 103 proceeds to step S411.

In S410, the controller 103 further adjusts the adjustment amount for the N-th link. The controller 103 increases the adjustment amount by adding any adjustment amount that increases according to the climb angle to the adjustment amount for the decrease in the travel speed or by multiplying the adjustment amount for the decrease in the travel speed by a coefficient of 1 or more that increases according to the climb angle. This allows for reflecting in the adjustment amount an increase in power consumption required for the vehicle 12 to increase output while decelerating to some extent when climbing a sharp slope.

When it is determined in S402 that there is no variation in the travel speed from that for the immediately preceding link, the controller 103 sets the adjustment amount to 0 in step S404 and proceeds to step S411.

In S411, the controller 103 determines whether the processing has completed for all links included in the travel route. When the processing has completed for all links (“Yes” in S411), the controller 103 terminates the procedure of FIG. 4. When the processing has not completed for all links (“No” in S411), the controller 103 increments the counter “N” in step S412 and returns to step S401. The controller 103 thus repeatedly executes steps S401 to S411 until the processing completes for all links. Therefore, the adjustment amounts of travel speeds are derived for all links. Then, the controller 103 terminates the procedure of FIG. 4.

Returning to FIG. 3, in step S306, the controller 103 derives a power consumption for each link. The controller 103 acquires identification information, vehicle type information, and the like on the vehicle 12, along with the route search request, for example, and acquires a power consumption rate for the vehicle 12 from the vehicle information 107. The controller 103 derives a power consumption according to the travel speed for each link, using the distance and travel speed for each link and the power consumption rate of the vehicle 12. When the travel route includes a fractional section that is shorter than one link, the controller 103 may proportionally calculate a power consumption, which is calculated from attribute information for a link corresponding to the distance of the fractional section, according to the distance of the section.

In S308, the controller 103 adjusts the power consumption for each link. The controller 103 adjusts the power consumption for each link using the adjustment amount of the power consumption derived in step S305. For example, the controller 103 adjusts the power consumption by multiplying the power consumption by a coefficient, which is derived as the adjustment amount for each link. This causes the power consumption to increase according to the coefficient, for each of links in which the travel speed has increased or decreased from that for the immediately preceding link.

In S309, the controller 103 derives a total power consumption for the travel route. The controller 103 sums the adjusted power consumptions for the respective links included in the travel route, to derive a total power consumption.

In S310, the controller 103 transmits information on the total power consumption for the travel route to the in-vehicle apparatus 13, along with information on the travel route. The in-vehicle device 13, upon receiving the information from the server apparatus 10, can then provide the driver with the total power consumption for traveling the searched travel route through image display or audio output, along with the searched travel route.

When multiple travel routes are searched in step S301 of FIG. 3, steps S302 to S310 are executed for each travel route.

By the operation procedure as described above, the server apparatus 10 can present the information on the travel route and the total power consumption to the driver via the in-vehicle apparatus 13. At that time, since the total power consumption is estimated based on the power consumption for each link according to the variation of the speed for each link, it is possible to derive the total power consumption more accurately. Therefore, it is possible to improve the estimation accuracy of power consumption in electric vehicles.

Cases in which part of the procedure in FIG. 4 is omitted are also included in the present embodiment. For example, when there is a variation in the travel speed from that for the immediately preceding link (“Yes” in step S402), the controller 103 can derive an adjustment amount according to the absolute value of the variation, regardless of whether the speed increases or decreases. In addition, when the travel speed decreases from that for the immediately preceding link (“decrease” in step S403), adjustment of the adjustment amount using the curvature (steps S407 to S408) and/or adjustment of the adjustment amount using the climb angle (steps S409 to S410) may be omitted. Alternatively, for links that are determined to have no variation in the travel speed, step S404 is executed, but steps S409 and 410 may be inserted afterward. That is, even for links with no variation in the travel speed, the power consumption may increase when the vehicle 12 accelerates on an uphill road to increase the travel speed. Therefore, when the climb angle is equal to or greater than a certain level, the controller 103 may reset a coefficient greater than 1, as the adjustment amount.

The above has described a case as an example in which the adjustment amount is a coefficient, but the adjustment amount may also be an increment for increasing the power consumption according to a variation range in the travel speed.

Some or all of the operations of the server apparatus 10 in the above embodiment may be executed by the in-vehicle apparatus 13. In such a case, part or all of the map information 108, the link attribute information 109, and the vehicle information 107 are stored in the memory 122 of the in-vehicle apparatus 13 in advance or by being acquired from the server apparatus 10, and part or all of the procedures in FIG. 3 and FIG. 4 may be executed by the controller 133. In such a case, the in-vehicle apparatus 13 corresponds to “information processing apparatus” of the present embodiment.

In the above embodiment, a processing/control program that specifies operations of the vehicle 12 may be stored in the memory 102 of the server apparatus 10 or in the memory of another server apparatus and downloaded to each apparatus via the network 11, or may be stored on a non-transitory recording/storage medium readable by each apparatus and read by each apparatus from the medium.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

Examples of some embodiments of the present disclosure are described below. However, it should be noted that the embodiments of the present disclosure are not limited to these examples.
[Appendix 1] An information processing apparatus comprising:
a memory configured to store information on a travel route for a vehicle that travels using electric power, and information on a speed for each link when the vehicle travels multiple links included in the travel route; and
a controller configured to output information on a total power consumption to be consumed by the vehicle to travel the travel route, based on a power consumption for each link according to a variation of the speed for each link.
[Appendix 2] The information processing apparatus according to appendix 1, wherein the speed for each link is an average speed when the vehicle travels the link.
[Appendix 3] The information processing apparatus according to appendix 1 to 2, wherein the controller is configured to adjust, according to the variation, a power consumption according to the speed for each link.
[Appendix 4] The information processing apparatus according to appendix 3, wherein when a first speed corresponds to a first link and a second speed different from the first speed corresponds to a second link next to the first link, the controller is configured to derive the total power consumption by adjusting a power consumption corresponding to the second speed by a predetermined adjustment amount.
[Appendix 5] The information processing apparatus according to appendix 4, wherein the controller is configured to determine the adjustment amount according to a variation of the second speed with respect to the first speed.
[Appendix 6] The information processing apparatus according to appendix 5, wherein the adjustment amount differs depending on whether the second speed increases or decreases with respect to the first speed.
[Appendix 7] The information processing apparatus according to appendix 5 or 6, wherein
the memory is configured to further store information on a curvature of a road in the second link, and
the controller is configured to determine the adjustment amount for the second speed further taking the curvature into account.
[Appendix 8] The information processing apparatus according to any one of appendices 5 to 7, wherein
the memory is configured to further store information on a slope angle of a road in the second link, and
the controller is configured to determine the adjustment amount for the second speed further taking the slope angle into account.
[Appendix 9] A method of operating an information processing apparatus, the method comprising:
acquiring information on a travel route for a vehicle that travels using electric power, and information on a speed for each link when the vehicle travels multiple links included in the travel route; and
outputting information on a total power consumption to be consumed by the vehicle to travel the travel route, based on a power consumption for each link according to a variation of the speed for each link.
[Appendix 10] The method according to appendix 9, wherein the speed for each link is an average speed when the vehicle travels the link.
[Appendix 11] The method according to appendix 9 or 10, further comprising adjusting, according to the variation, a power consumption according to the speed for each link.
[Appendix 12] The method according to appendix 9, wherein when a first speed corresponds to a first link and a second speed different from the first speed corresponds to a second link next to the first link, the total power consumption is derived by adjusting a power consumption corresponding to the second speed by a predetermined adjustment amount.
[Appendix 13] The method according to appendix 12, wherein the adjustment amount is determined according to a variation of the second speed with respect to the first speed.
[Appendix 14] The method according to appendix 13, wherein the adjustment amount differs depending on whether the second speed increases or decreases with respect to the first speed.
[Appendix 15] The method according to appendix 13 or 14, wherein the adjustment amount for the second speed is determined further taking into account information on a curvature of a road in the second link.
[Appendix 16] The method according to any one of appendices 13 to 15, wherein the adjustment amount for the second speed is determined further taking into account information on a slope angle of a road in the second link.

1. An information processing apparatus comprising:
a memory configured to store information on a travel route for a vehicle that travels using electric power, and information on an average speed for each link when the vehicle travels multiple links included in the travel route; and
a controller configured to:
derive a coefficient for adjustment according to a mutual variation of the average speed between consecutive links;
adjust a statistical power consumption of the vehicle for each link by multiplying the statistical power consumption by the coefficient; and
derive a total power consumption to be consumed by the vehicle to travel the travel route by summing adjusted power consumptions,
wherein the controller is configured to transmit information on the total power consumption to an in-vehicle apparatus of the vehicle and cause the in-vehicle apparatus to output the information on the total power consumption.

2. An information processing apparatus comprising:
a memory configured to store information on a travel route for a vehicle that travels using electric power, and information on a speed for each link when the vehicle travels multiple links included in the travel route; and
a controller configured to output information on a total power consumption to be consumed by the vehicle to travel the travel route, based on a power consumption for each link according to a variation of the speed for each link.

3. The information processing apparatus according to claim 2, wherein the speed for each link is an average speed when the vehicle travels the link.

4. The information processing apparatus according to claim 2, wherein the controller is configured to adjust, according to the variation, a power consumption according to the speed for each link.

5. The information processing apparatus according to claim 4, wherein when a first speed corresponds to a first link and a second speed different from the first speed corresponds to a second link next to the first link, the controller is configured to derive the total power consumption by adjusting a power consumption for the second link by a predetermined adjustment amount.

6. The information processing apparatus according to claim 5, wherein the controller is configured to determine the adjustment amount according to a variation of the second speed with respect to the first speed.

7. The information processing apparatus according to claim 6, wherein the adjustment amount differs depending on whether the second speed increases or decreases with respect to the first speed.

8. The information processing apparatus according to claim 6, wherein
the memory is configured to further store information on a curvature of a road in the second link, and
the controller is configured to determine the adjustment amount for the second speed further taking the curvature into account.

9. The information processing apparatus according to claim 6, wherein
the memory is configured to further store information on a slope angle of a road in the second link, and
the controller is configured to determine the adjustment amount for the second speed further taking the slope angle into account.

10. A method of operating an information processing apparatus, the method comprising:
acquiring information on a travel route for a vehicle that travels using electric power, and information on a speed for each link when the vehicle travels multiple links included in the travel route; and
outputting information on a total power consumption to be consumed by the vehicle to travel the travel route, based on a power consumption for each link according to a variation of the speed for each link.

11. The method according to claim 10, wherein the speed for each link is an average speed when the vehicle travels the link.

12. The method according to claim 10, further comprising adjusting, according to the variation, a power consumption according to the speed for each link.

13. The method according to claim 12, wherein when a first speed corresponds to a first link and a second speed different from the first speed corresponds to a second link next to the first link, the total power consumption is derived by adjusting a power consumption corresponding to the second speed by a predetermined adjustment amount.

14. The method according to claim 13, wherein the adjustment amount is determined according to a variation of the second speed with respect to the first speed.

15. The method according to claim 14, wherein the adjustment amount differs depending on whether the second speed increases or decreases with respect to the first speed.

16. The method according to claim 14, wherein the adjustment amount for the second speed is determined further taking into account information on a curvature of a road in the second link.

17. The method according to claim 14, wherein the adjustment amount for the second speed is determined further taking into account information on a slope angle of a road in the second link.
